(19) United States
(12) Patent Application Publication
(10) Pub. No.: US 2021/0121995 A1
(43) Pub. Date: Apr. 29, 2021

(54) METHOD OF GRINDING AND TURNING A WORKPIECE

(71) Applicant: Fives Landis Corp., Hagerstown, MD (US)

(72) Inventors: Timothy William Hykes, Greencastle, PA (US); Joel Kym Metzler, Greencastle, PA (US); Joseph Robert Needham, Chambersburg, PA (US)

(21) Appl. No.: 17/073,614

(22) Filed: Oct. 19, 2020

Related U.S. Application Data
(60) Provisional application No. 62/925,285, filed on Oct. 24, 2019.

(51) Int. Cl. B23Q 3/18; B23Q 17/22; B23Q 3/152

(52) U.S. Cl. CPC B23Q 3/183; B23Q 2017/001; B23Q 3/152; B23Q 17/2291

(57) ABSTRACT

A method of grinding or turning a workpiece, such as a bearing workpiece, involves several steps. One step includes locating the bearing workpiece on a chuck with an axis of rotation of the chuck positioned off-center relative to an axis of the bearing workpiece. Another step includes determining an offset between the chuck's axis of rotation and the bearing workpiece's axis based on the off-center position between the chuck's axis of rotation and the bearing workpiece's axis. Yet another step includes determining a path of engagement of a grinding wheel relative to the bearing workpiece based on the offset previously determined between the chuck's axis of rotation and the bearing workpiece's axis.

### CROSS-REFERENCE TO RELATED PATENT APPLICATION

This is a U.S. non-provisional patent application which claims the benefit of U.S. provisional patent application No. 62/925,285, filed on Oct. 24, 2019, the entire contents of which are hereby incorporated by reference.

### FIELD OF THE DISCLOSURE

The disclosure relates generally to the manufacture of metal workpieces, and more particularly to methods of grinding and turning metal bearing workpieces and other metal workpieces with annular portions.

### BACKGROUND

Bearings are mechanical devices used to reduce friction between two components that have relative movement between them, most often rotational movement. Depending on the type, bearing components can include inner bearing rings and outer bearing rings. Surface quality and tight dimensional accuracy resulting from grinding and finishing manufacturing operations of bearing rings and other components are key to ensure the lifetime of bearings. Grinding is typically performed on inner and outer diameters of bearing rings, as well as raceways and ribs and chamfers and grooves, as called for. Grinding is also typically performed on other metal workpieces having annular portions.

A conventional approach to grinding bearing rings known as the shoe-centerless approach involves holding a bearing ring at an off-center location on a magnetic chuck. The bearing ring is held in place by shoes. While sufficient, the approach is not without drawbacks. Grinding effectiveness is highly sensitive to relationships among grinding wheel-to-workpiece contact angle and shoe-to-workpiece contact angle. Moreover, grinding wheels tend to wear over time, making it increasingly difficult to maintain favorable grinding conditions. These relationships demand a rigorous and time-consuming setup process by a highly skilled operator. Because of the burdensome setup process, the shoe-centerless approach is most ideal for higher production volume manufacturing operations, and less suitable for lower production volume manufacturing operations and those that call for increased changeover and flexibility.

Another known approach for grinding or turning bearing rings involves centering a bearing ring on a magnetic chuck by manually tapping the bearing ring with a hammer or by moving the bearing ring with computer numerical controlled (CNC) push devices. Again here, this approach has shortcomings. It too demands a rigorous and time-consuming setup process. This approach has been employed for lower production volume manufacturing operations.

### SUMMARY

An implementation of a method of grinding or turning a workpiece may involve several steps. The workpiece has one or more annular portions. One step may include locating the workpiece on a chuck with an axis of rotation of the chuck positioned off-center relative to an axis of the workpiece at the annular portion(s). Another step may include determining an offset between the chuck's axis of rotation and the workpiece's axis based on the off-center position between the chuck's axis of rotation and the workpiece's axis. Yet another step may include determining a path of engagement of a grinding wheel relative to the workpiece based on the offset previously determined between the chuck's axis of rotation and the workpiece's axis.

Another implementation of a method of turning a workpiece may involve several steps. The workpiece has one or more annular portions. One step may include locating the workpiece on a chuck with an axis of rotation of the chuck positioned off-center relative to an axis of the workpiece at least one annular portion. Another step may include determining an offset between the axis of rotation of the chuck and the axis of the workpiece as a result of the off-center position between the axis of rotation of the chuck and the axis of the workpiece. And another step may include determining a path of engagement of a turning tool relative to the workpiece based on the determined offset between the axis of rotation of the chuck and the axis of the workpiece.

### BRIEF DESCRIPTION OF THE DRAWINGS

FIG. 1 is a schematic view of an embodiment of one step in a method of grinding a bearing workpiece;

FIG. 2 is a schematic view of the step of the method of grinding a bearing workpiece;

FIG. 3 is a schematic view of another step of the method of grinding a bearing workpiece;

FIG. 4 is a schematic view of yet another step of the method of grinding a bearing workpiece; and

FIG. 5 is a schematic view of yet another step of the method of grinding a bearing workpiece.

### DETAILED DESCRIPTION

Turning now to the figures, an embodiment of a method of grinding and turning a bearing workpiece is schematically depicted and described herein. Compared to past approaches, the method set forth in this description is more suitable for lower production volume manufacturing operations such as those producing one to one-thousand parts, and is also suitable for higher production volume manufacturing operations. The method of grinding and turning a bearing workpiece has a speedier setup process than past approaches, and does not require any level of manual manipulation of the bearing workpiece and can altogether lack the use of shoes for holding the bearing workpiece in place. Increased changeover and greater flexibility in manufacturing operations is hence achieved. The method of grinding and turning a bearing workpiece is more efficient and more effective than past approaches. The method can have more, less, and/or different steps in various embodiments and than those described herein, depending in some cases on the precise bearing workpiece subject to the grinding or turning operation.

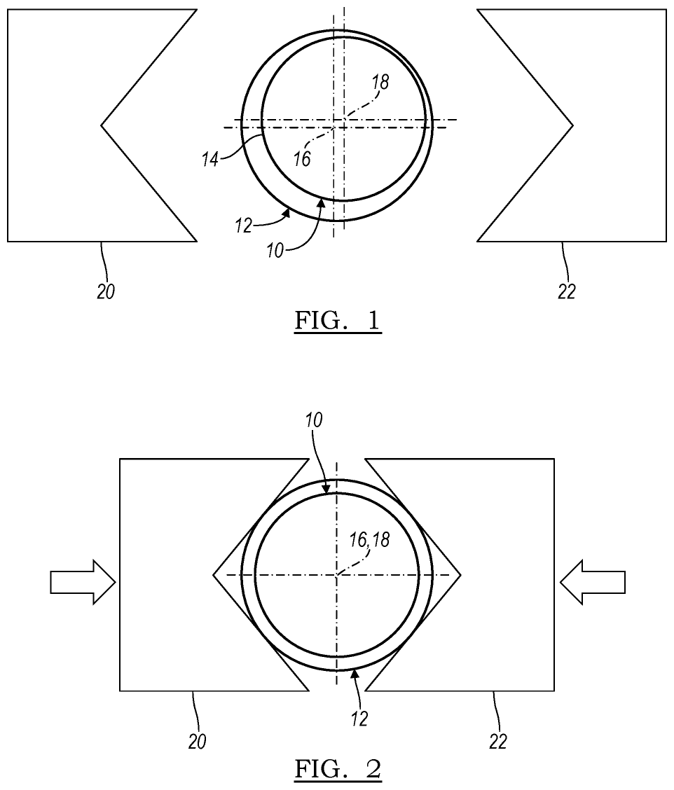

FIGS. 1 and 2 depict an embodiment of a first step in the method. The first step involves locating a bearing workpiece 10 on a chuck 12. The bearing workpiece 10 can be an inner bearing ring, an outer bearing ring, or some other metal annular bearing component. The chuck 12 is a magnetic chuck in this embodiment, but the chuck 12 could be another type of chuck such as a mechanical chuck. One benefit of a magnetic chuck, when employed without shoes, is that no area of the bearing workpiece 10 is physically obstructed from grinding by shoes, fixtures, or other holding objects. Still, in some embodiments, shoes, fixtures, or other holding objects can be used in the method detailed in this description. The bearing workpiece 10 can be initially set in place directly on a backing plate 14 of the chuck 12 via an automatic or manual technique such as by robotics, by an integrated loader, or by hand by an operator. At this stage, the bearing workpiece 10 can be in a so-called black state in which the bearing workpiece 10 has been machined and hardened and has had its flat surfaces ground by a disc. Once set in place, the chuck 12 can initially lightly hold the bearing workpiece 10 for the locating step.

Locating the bearing workpiece 10 on the chuck 12 is an approximate and rough centering of the bearing workpiece 10 on the chuck 12. In some embodiments, for example, an axis of rotation 16 of the chuck 12 results in a position that is eccentric and off-center and offset with respect to an axis 18 of the bearing workpiece 10 by as much as approximately 1.0 millimeters (mm) or within approximately 50 micrometers (μm) of optimum concentricity. The chuck 12 revolves about its axis of rotation 16 during use, and the axis 18 of the bearing workpiece 10 is a central axis of the circular shape thereof. Due to the off-center positioning, the axis 18 travels over an eccentric path upon rotation of the chuck 12. The rough centering is carried out in this embodiment via a pair of centering vees—a first centering vee 20 and a second centering vee 22—that come together (FIG. 2) and engage the bearing workpiece 10 and bring the bearing workpiece 10 to an approximate center position relative to the chuck 12. The first and second centering vees 20, 22 subsequently retract. In the approximate center position, the axis of rotation 16 of the chuck 12 and the axis 18 of the bearing workpiece 10 are slightly misaligned and offset relative to each other. Still, other types of procedures for locating and rough centering the bearing workpiece 10 on the chuck 12 are possible; for example, the locating and rough centering can be carried out via shoe element centering mechanisms and/or contact members. Whatever type of locating and rough centering procedure is employed, once concluded the chuck 12 augments its hold of the bearing workpiece 10. In the example of the magnetic chuck, the magnetic setting is increased to effect a holding exertion that can be in the range of approximately 100 to 150 Newtons per centimeters squared (N/cm²); of course, other holding magnitudes are possible.

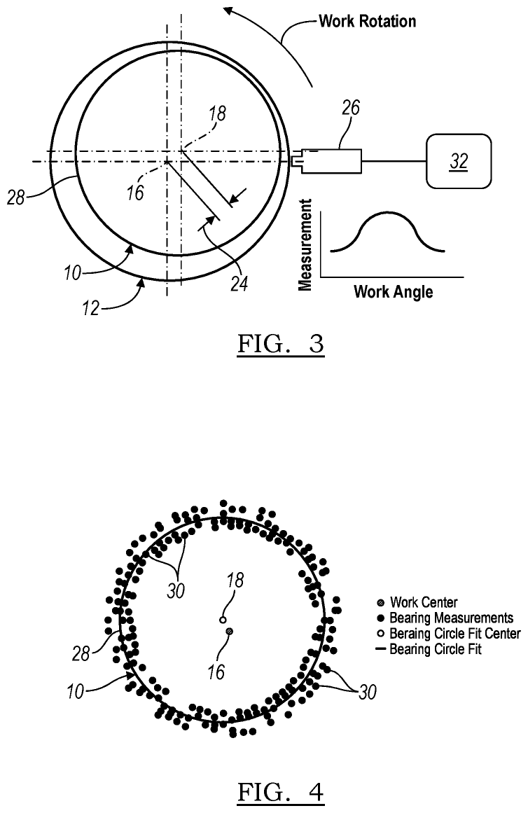

FIGS. 3 and 4 depict an embodiment of another step in the method of grinding and turning the bearing workpiece 10. This step involves determining an offset 24 between the axis of rotation 16 of the chuck 12 and the axis 18 of the bearing workpiece 10. The offset 24 is the result of the locating and rough centering procedure of the previous step. This step of determining the offset 24 can involve various techniques in different embodiments. In one embodiment, a probe 26 is employed to take measurements of an outer diameter 28 of the bearing workpiece 10. Measuring the outer diameter 28 is in preparation for performing a grinding or turning operation thereon; for grinding or turning an inner diameter of the bearing workpiece 10, as another example, the inner diameter would be subject to measurements. The probe 26 could be a contact-based or a non-contact-based measurement implement. For example, the probe 26 could be a linear variable differential transformer (LVDT) gauge, an eddy current probe, an encoder probe, an inductive sensor, a laser triangulation sensor, or a confocal sensor, to name a few types. FIG. 4 is a schematic demonstration of multiple measurements 30 taken by the probe 26 of an example outer diameter 28 of the bearing workpiece 10. The probe 26 in this example was of the inductive probe type. The measurements 30 can be taken as the bearing workpiece 10 is driven to rotate via the chuck 12 and as the measurement implement remains stationary, or, as an alternative, the measurement implement can itself revolve around the bearing workpiece 10; the precise measuring technique can be dictated by the measurement implement used. In this embodiment, a controller 32 (FIG. 3), such as a computer numerical control (CNC) controller, receives the measurements 30 and generates a polar coordinate system (0, r) via a data table in polar format. A calculation can then be performed at the controller 32 in order to determine a position and location of the axis 18 of the bearing workpiece 10. The precise calculation may be dictated by the expected magnitude of the offset 24. That is, for instance, a least squares fit approach based on the measurements 30 can be utilized to determine the bearing workpiece's axis 18, or another similar algorithm can be used. Still, for smaller expected magnitudes of the offset 24, an average value of the measurements 30 can be utilized to determine a vector length of the offset 24 and location of a minimum/maximum of an angle of the offset 24. Once the axis 18 of the bearing workpiece 10 is determined, its location is compared to the location of the axis of rotation 16 of the chuck 12. The axis of rotation 16 of the chuck 12 can have a known value based on the particular chuck selected for use and its workhead center.

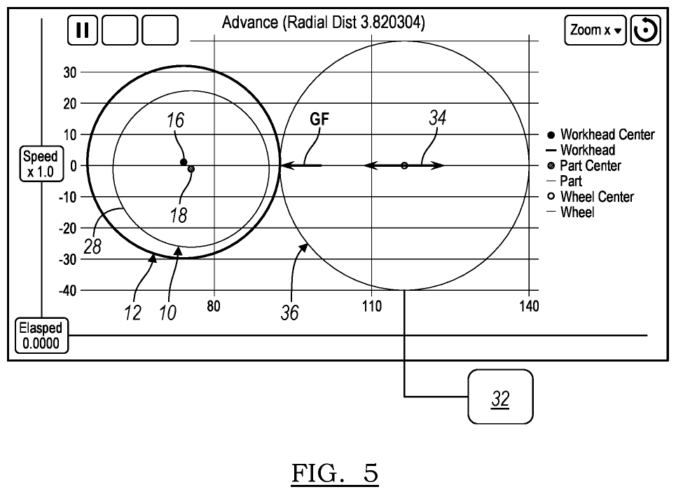

Another step in the method of grinding and turning the bearing workpiece 10 is depicted in FIG. 5. This step involves determining a path of engagement 34 of a grinding wheel 36 relative to the bearing workpiece 10. The determination is based on the previously determined offset 24 between the chuck's axis of rotation 16 and the bearing workpiece's axis 18. The path of engagement 34 is the line of travel over which the grinding wheel 36 moves to engage the bearing workpiece 10 to remove material from the bearing workpiece 10 during a grinding operation. The path of engagement 34 guides the grinding wheel 36 to performed grinding on the outer diameter 28 of the bearing workpiece 10 or on the inner diameter of the bearing workpiece 10, as well as to raceways and ribs and chamfers and grooves of the bearing workpiece 10, as needed. Due to the offset 24, the bearing workpiece 10 revolves about an eccentric route as the chuck 12 rotates amid use. The grinding wheel 36 moves along its determined path of engagement 34 to accommodate the eccentric route of the rotating bearing workpiece 10 in order to maintain a point of contact with the bearing workpiece 10. The point of contact between the grinding wheel 36 and the bearing workpiece 10 is hence maintained over the entire circumference of the bearing workpiece 10. The path of engagement 34 is determined at the controller 32. Movement of the grinding wheel 36 can be effected via one or more servo motors or some other type of mechanism operatively interacting with the grinding wheel 36. In this embodiment, the path of engagement 34 is a linear path, and is solely a reciprocation path of the grinding wheel 36 toward and away from the bearing workpiece 10. In other words, the grinding wheel 36 moves forward and rearward only. Its forward and rearward movement is horizontal, as demonstrated in the depiction of FIG. 5, but could be along any linear path that is arranged in a normal direction relative to the bearing workpiece 10 including non-horizontal paths.

In addition to the offset 24, determining the path of engagement 34 is a calculation that can take into account other factors that may impact the determination of the path of engagement 34 and maintaining the point of contact between the grinding wheel 36 and the bearing workpiece 10. In different embodiments, and depending in some instances on the precise chuck 12 employed in the method, the determination of the path of engagement 34 can include correction factors for certain geometric errors such as for centerline height error of a wheel spindle, a compensation for a diameter of the grinding wheel 36, and/or correction factors based on inherent imprecisions and tolerances of the chuck 12 such as its axis of rotation 16 and the larger chuck machine, among other possible factors. Furthermore, in an embodiment that lacks shoes, in order to ensure roundness precision of the bearing workpiece 10, the chuck 12 may be selected to exhibit sub-micron rotational accuracy. A hydrostatic work spindle or grinding wheel spindle, in some embodiments, may be called for. In certain embodiments also, a scrubber can be employed to assist cleanliness of the grinding wheel 36.

Still, other embodiments of the method can involve additional and/or different steps. For example, in an embodiment the method can include maintaining a grinding force GF (FIG. 5) below a certain threshold force in order to preclude the bearing workpiece 10 from unwanted movement on the backing plate 14 amid operation and with respect to the chuck 12. The grinding force GF is directed normal to the bearing workpiece 10, as illustrated by FIG. 5. The threshold force can be that which overcomes the holding exertions of the magnetic chuck, when the magnetic chuck option is used and when holding the bearing workpiece 10 lacks the use of shoes. Furthermore, in embodiments of the method, the method can be repeated and rerun with grinding wheels of finer and finer abrasives at the single chuck 12, rather than having to introduce the bearing workpiece 10 to a separate and discrete chuck machine setting at a different site as in the past.

As described, the method and its various steps can be employed for grinding the bearing workpiece 10 or for turning the bearing workpiece 10. For turning operations, in place of the grinding wheel 36, a cutting tool would be used to engage the bearing workpiece 10 and remove material therefrom. Turning can be performed on the outer diameter 28 of the bearing workpiece 10 or on the inner diameter of the bearing workpiece 10, as well as to raceways and ribs and chamfers and grooves of the bearing workpiece 10, as needed.

Still further, while the method and its various steps for grinding and turning have been described with reference to a bearing workpiece, the method has a more expansive scope of application and can be carried out on non-bearing metal workpieces with annular portions. In addition, the method can be carried out on non-annular profile portions on certain bearing workpieces, such as those found in aerospace applications. In this example application, an annular profile portion of the bearing workpiece would serve as a reference location for grinding or turning of the non-annular profile portion. In the steps previously described, the first step would be performed as described—that is, the bearing workpiece would be located on a chuck via its annular profile portion. The next step, as described, would involve determining an offset between the chuck's axis of rotation and the axis of the bearing workpiece by taking measurements of the annular profile portion. In a subsequent step, not previously described, the reference location of the annular profile portion with respect to the non-annular profile portion would be incorporated into the step of determining the path of engagement of the grinding wheel or the cutting tool. In an example, the reference location of the annular profile portion relative to the non-annular profile portion could be an axial displacement between the two portions and/or a radial displacement between the two portions or some other displacement of the grinding wheel or cutting tool prior to movement of the wheel/tool over the path of engagement to remove material from the bearing workpiece.

Having thus described the method, various modifications and alterations will occur to those skilled in the art, which modifications and alterations will be within the scope of the appended claims.

1. A method of grinding a metal workpiece having at least one annular portion, the method comprising:
locating the workpiece on a chuck with an axis of rotation of said chuck positioned off-center relative to an axis of the workpiece at the at least one annular portion;
determining an offset between the axis of rotation of the chuck and the axis of the workpiece as a result of the off-center position between the axis of rotation of the chuck and the axis of the workpiece; and
determining a path of engagement of a grinding wheel relative to the workpiece based on the determined offset between the axis of rotation of the chuck and the axis of the workpiece.

2. The method as set forth in claim 1, wherein the workpiece is a bearing workpiece.

3. The method as set forth in claim 2, further comprising engaging the bearing workpiece with the grinding wheel at an outer diameter of the bearing workpiece, at an inner diameter of the bearing workpiece, at a raceway of the bearing workpiece, at a rib of the bearing workpiece, at a chamfer of the bearing workpiece, or at a groove of the bearing workpiece.

4. The method as set forth in claim 1, wherein locating the workpiece on said chuck comprises engaging the workpiece with at least one centering vee.

5. The method as set forth in claim 1, wherein locating the workpiece on said chuck lacks involvement of a shoe.

6. The method as set forth in claim 1, wherein said chuck is a magnetic chuck.

7. The method as set forth in claim 1, wherein determining the offset between the axis of rotation of the chuck and the axis of the workpiece comprises determining the offset using a polar coordinate system.

8. The method as set forth in claim 1, wherein determining the offset between the axis of rotation of the chuck and the axis of the workpiece comprises determining the offset via a contact or non-contact sensor.

9. The method as set forth in claim 1, wherein determining the offset between the axis of rotation of the chuck and the axis of the workpiece comprises measuring a diameter of the workpiece.

10. The method as set forth in claim 1, wherein determining the offset between said axis of rotation of said chuck and said axis of the workpiece comprises determining said axis of the bearing workpiece.

11. The method as set forth in claim 10, wherein determining the axis of the workpiece comprises determining the axis of the workpiece via a least squares fit approach.

12. The method as set forth in claim 1, wherein the determined path of engagement of the grinding wheel relative to the workpiece is solely a reciprocation path of engagement of the grinding wheel toward and away from the workpiece.

13. The method as set forth in claim 1, wherein the determined path of engagement of the grinding wheel relative to the workpiece is a horizontal path of engagement of the grinding wheel toward and away from the workpiece.

14. The method as set forth in claim 1, wherein the determined path of engagement of the grinding wheel relative to the workpiece is an engagement of a non-annular portion of the workpiece, and wherein the path of engagement is determined based on a reference location of said non-annular portion relative to the at least one annular portion.

15. The method as set forth in claim 1, further comprising:
maintaining a grinding force directed normal to the workpiece less than a threshold force to preclude unwanted movement of the workpiece with respect to said chuck.

16. A method of turning a workpiece having at least one annular portion, the method comprising:
locating the workpiece on a chuck with an axis of rotation of the chuck positioned off-center relative to an axis of the workpiece at the at least one annular portion;
determining an offset between the axis of rotation of the chuck and the axis of the workpiece as a result of the off-center position between the axis of rotation of the chuck and the axis of the workpiece; and
determining a path of engagement of a turning tool relative to the workpiece based on the determined offset between the axis of rotation of the chuck and the axis of the workpiece.
